(19) United States
(12) Patent Application Publication
(10) Pub. No.: US 2010/0017673 A1
(43) Pub. Date: Jan. 21, 2010

(54) DATA TRANSMISSION SYSTEM AND DATA TRANSMISSION METHOD

(75) Inventors: Jiping LU, Beijing (CN); Hideya YOSHIUCHI, Beijing (CN)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/500,772

(22) Filed: Jul. 10, 2009

(30) Foreign Application Priority Data
Jul. 15, 2008 (CN) 200810133924.3

(51) Int. Cl. H04L 1/08; G06F 11/14; G06F 11/07

(52) U.S. Cl. 714/749; 714/746; 714/E11.023; 714/E11.131

(57) ABSTRACT

A data transmission system includes a server, a network and a plurality of terminals. The server sends data to the terminals via the network and the network connects the server and the plurality of terminals, and the terminal includes a network interface unit that connects to the network and communicates with the other terminals or the server via the network, a storage unit that stores reception data and information on missing of data, a detection unit that detects that the reception data is missing or damaged, and a controller that controls the network interface unit to send a repair request message to the other terminals through multicast when the detection unit detects missing or damaged data of data received from the server, and that controls the network interface unit to send a repair request message to the server when there is not requested data in the other terminals.

### INCORPORATION BY REFERENCE

The present application claims priority from Chinese application CN P200810133924.3 filed on Jul. 15, 2008, the content of which is hereby incorporated by reference into this application.

### BACKGROUND OF THE INVENTION

The present invention relates to a data transmission system and a data transmission method and, more particularly, to a data transmission system and data transmission method for client terminals, which relieves a transmission load of a server in a video on demand system.

In the video on demand system, a client terminal sends a data request message to a server when requesting a program. When sending the same data to a plurality of terminals through multicast based on the request message, the server may send only one data copy. However, in a number of applications, information is currently distributed using a low reliable multicast protocol.

In a certain application, all terminals are required to be able to receive perfect data. For the purpose of realizing a highly reliable multicast data transmission, when a terminal detects damaged or missing data of data sets, a method for transmitting a report message for missing data to a server is frequently used as one method. However, the method requires processing of a large number of report messages for missing data using the server, and a plurality of times of retransmission are performed for the same data to consume massive resources and to occupy band widths.

Various systems and methods for reducing data retransmissions have already been frequently proposed. In a highly reliable multicast data transmission system proposed in, for example, the “method and system for highly reliable multicast data transmission” of Patent Document 1, the server sends data to terminals through a multicast channel and the terminals feed back a report for damaged or missing data to the server through a control channel. For reducing data retransmissions, the server collects up retransmission requests from the terminals, and then retransmits repair data through the multicast channel. The above is described in U.S. Pat. No. 7,289,500.

### SUMMARY OF THE INVENTION

Data retransmissions from a server to terminals are reduced using the above-described method; however, the same retransmission requests from the terminals to the server are not reduced. A large number of the same retransmission requests consume resources of the server and occupy its band widths.

Accordingly, it is required to provide a method for reducing the retransmission requests from the terminals to the server and for avoiding a retransmission request congestion problem due to a fact that the same retransmission requests reach the server at the same time.

In view of the foregoing, it is an object of the present invention to solve the above-described problems. More specifically, it is an object of the present invention to provide a data transmission system and data transmission method capable of highly reliable multicast transmission of data, which can reduce data retransmissions from the server to the terminals, and reduce the same retransmission requests from the terminals to the server to save the band width, and further, avoid the retransmission request congestion problem due to a fact that a large number of the same retransmission requests reach the server at the same time.

To accomplish the above-described objects, according to one aspect of the present invention, there is provided a data transmission system. This system includes a server, a network and a plurality of terminals, and the server sends data to the terminals via the network and the network connects the server and the plurality of terminals, wherein the terminal includes a network interface unit that connects to the network and communicates with the other terminals or the server via the network, a storage unit that stores reception data and information on missing of data, a detection unit that detects that the reception data is missing or damaged and a controller that controls the network interface unit to send a repair request message to the other terminals through multicast when the detection unit detects damaged or missing data among data sets received from the server, and that controls the network interface unit to send a repair request message to the server when there is not requested data in the other terminals.

To accomplish the above-described objects, according to another aspect of the present invention, there is provided a data transmission method in a data transmission system including a server, a network, and a plurality of terminals. This method includes causing the server to send data to the plurality of terminals via the network through multicast, causing the terminal to detect that reception data is missing or damaged, causing the terminal to send a repair request message to the other terminals through multicast when missing or damaged data is detected, causing the terminal to repair the missing or damaged data when the terminal receives data sent from the other terminals, causing the terminal to send a repair request message to the server when data sent from the other terminals is not received after a predetermined time has elapsed, and causing the terminal to receive data retransmitted from the server through multicast to repair the missing or damaged data.

To accomplish the above-described objects, according to yet another aspect of the present invention, there is provided a terminal. This terminal includes a network interface unit that connects to a network and communicates with the other terminals or a server via the network, a storage unit that stores reception data and information on missing of data, a detection unit that detects that the reception data is missing or damaged, and controller that controls the network interface unit to send a repair request message to the other terminals through multicast when the detection unit detects missing or damaged data among data sets received from the server, and that controls the network interface unit to send a repair request message to the server when there is not requested data in the other terminals.

In the above-described system and method, when reducing repair request messages sent from the terminals to the server, there can be avoided the repair request congestion problem due to a fact that a large number of the same repair request messages reach the server from the terminals at the same time.

Other objects, features and advantages of the invention will become apparent from the following description of the embodiments of the invention taken in conjunction with the accompanying drawings.

### BRIEF DESCRIPTION OF THE DRAWINGS

FIG. 1 is a layout drawing illustrating a data transmission system according to the present embodiment of the invention;

FIG. 2A is a system architecture diagram of a server in the data transmission system according to the present embodiment of the invention;

FIG. 2B is a file record sketch illustrating a data repair request database in the server;

FIG. 3A is a system architecture diagram of a terminal according to the present embodiment of the invention;

FIG. 3B is a file record sketch illustrating a missing packet database of the terminal according to the present embodiment of the invention;

FIG. 4A is a signaling flow diagram in which the terminal requests repair data;

FIG. 4B is a signaling flow diagram in which the terminal requests repair data;

FIG. 4C is a signaling flow diagram in which the terminal requests repair data;

FIG. 4D is a signaling flow diagram in which the terminal requests repair data;

FIG. 5 is a flowchart in which the server receives and processes a repair request from the terminal;

FIG. 6A is a flowchart in which the terminal receives data to perform an integrity test;

FIG. 6B is a flowchart in which the terminal receives and processes a repair request;

FIG. 6C is a flowchart in which the terminal performs timer inspection to a missing record; and

FIG. 7 is a combined sketch illustrating a data transmission format and a repair request message format.

### DESCRIPTION OF THE EMBODIMENTS

For fully understanding the present invention, specific embodiments according to the present invention will be described in detail below with reference to the accompanying drawings.

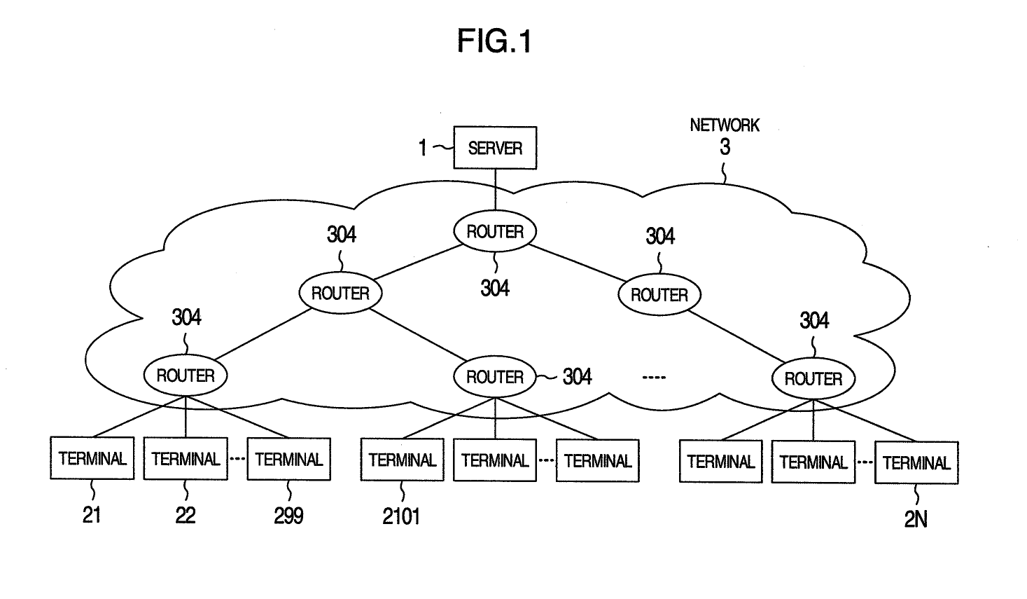

FIG. 1 is a layout drawing illustrating a data transmission system according to the present embodiment of the invention. The system includes a server 1, a plurality of terminals 2, and a network 3. The network 3 includes routers 304 and other network devices, and supports unicast and multicast protocols. The server 1 and the plurality of terminals 2 are connected via the network 3. The server 1 sends data to the plurality of terminals 2 according to a low reliable multicast protocol, and the terminal 2 sends a retransmission request to the server 1 according to a highly reliable unicast protocol.

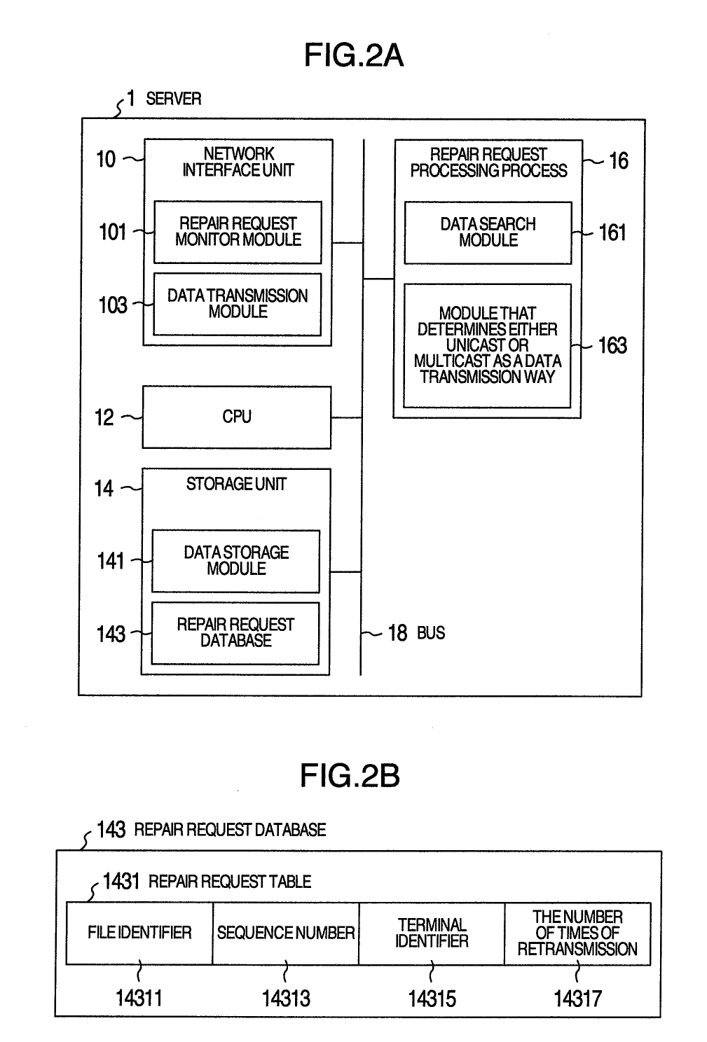

FIG. 2A is a system architecture diagram of the server 1 in the data transmission system according to the present embodiment of the invention. The server 1 includes a network interface unit 10, a central processing unit (CPU) 12, a storage unit 14, a repair request processing unit 16, and a bus 18 for connecting respective units. The network interface unit 10 includes a repair request monitor module 101 and a data transmission module 103. The repair request monitor module 101 monitors a repair request message and a related control message. The data transmission module 103 sends data to the terminals. A data storage module 141 of the storage unit 14 stores transmission data, and in a repair request database 143, repair request information from the terminals is recorded. The repair request processing unit 16 processes repair requests from the terminals. The data search module 161 searches for data blocks necessary for retransmission, and determines either unicast or multicast as a data transmission unit. Based on the number of times of retransmission request, a module 163 determines either the transmission to the terminal through highly reliable unicast or the transmission to all the terminals through multicast. FIG. 2B is a file record sketch illustrating the data repair request database in the server 1. A repair request table 1431 of the repair request database 143 includes items of a file identifier 14311, a sequence number 14313, a terminal identifier 14315, and the number of times of retransmission 14317. The file identifier 14311 uniquely identifies one file, and the sequence number 14313 specifies a position of the file of data necessary for retransmission. The terminal identifier 14315 uniquely identifies one terminal, and may be an IP address or MAC address of the terminal. The number of times of retransmission of the data to the terminal is recorded in the field of the number of times of retransmission 14317.

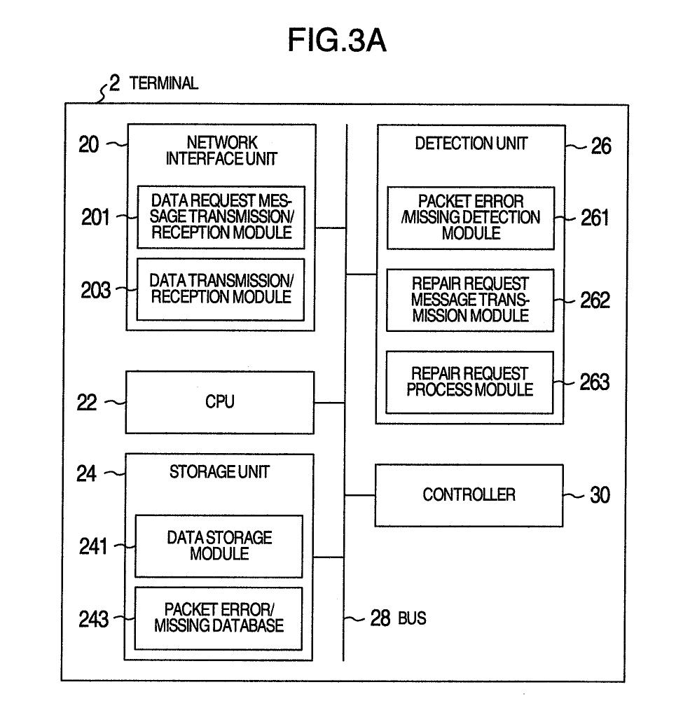

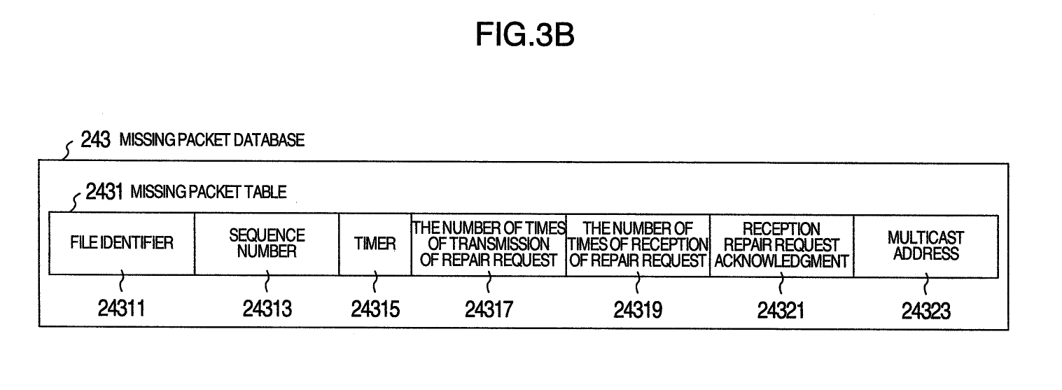

FIG. 3A is a system architecture diagram of the terminal 2 according to the present embodiment of the invention, and FIG. 3B is a file record sketch illustrating a missing packet database of the terminal 2 according to the present embodiment of the invention. The terminal 2 according to the present embodiment includes a network interface unit 20, a CPU 22, a storage unit 24, a detection unit 26, a controller 30, and a bus 28 for connecting respective units. A repair request transmission/reception module 201 of the network interface unit 20 sends a repair request to the other terminals or the server 1, and receives and processes a repair request message sent from the other terminals. A data transmission/reception module 203 transfers request data to the other terminals 2, and receives data from the server 1 or the other terminals 2. A data storage module 241 of the storage unit 24 stores reception data. In a missing packet database 243, missing information for data is recorded. The detection unit 26 performs an integrity test to reception data, and repairs the missing or damaged data. A packet error/missing detection module 261 detects whether the reception data is correct and whether the reception data is missing, and records error or missing information for the data in the missing packet database 243. Further, the repair request message transmission module 262 sends a repair request message to the server 1 or the other terminals 2 to repair error or missing data. The repair request process module 263 processes a repair request message sent from the other terminals 2, searches for whether there is requested data from the other terminals 2, and transfers repair data to the other terminals 2 when there is the requested data.

The missing packet table 2431 of the missing packet database 243 includes items of a file identifier 24311, a sequence number 24313, a timer 24315, the number of times of transmission of repair request 24317, the number of times of reception of repair request 24319, reception repair request acknowledgment 24321, and a multicast address K 24323. The file identifier 24311 uniquely identifies one file. In the field of the sequence number 24313, a position of missing data in a file is recorded. In the field of the timer 24315, a time for inducing a repair request transmission event is recorded. In the field of the number of times of transmission of repair request 24317, how many times the terminal sends a repair request message corresponding to the data is recorded. In the field of the number of times of reception of repair request 24319, how many times the terminal receives a repair request corresponding to the data sent from the other terminals is recorded. In the field of the reception repair request acknowledgment 24321, whether the terminal receives a repair request acknowledgment message sent from the other terminals is recorded. In the field of the multicast address K 24323, a multicast address used for transmission of the repair request message is recorded.

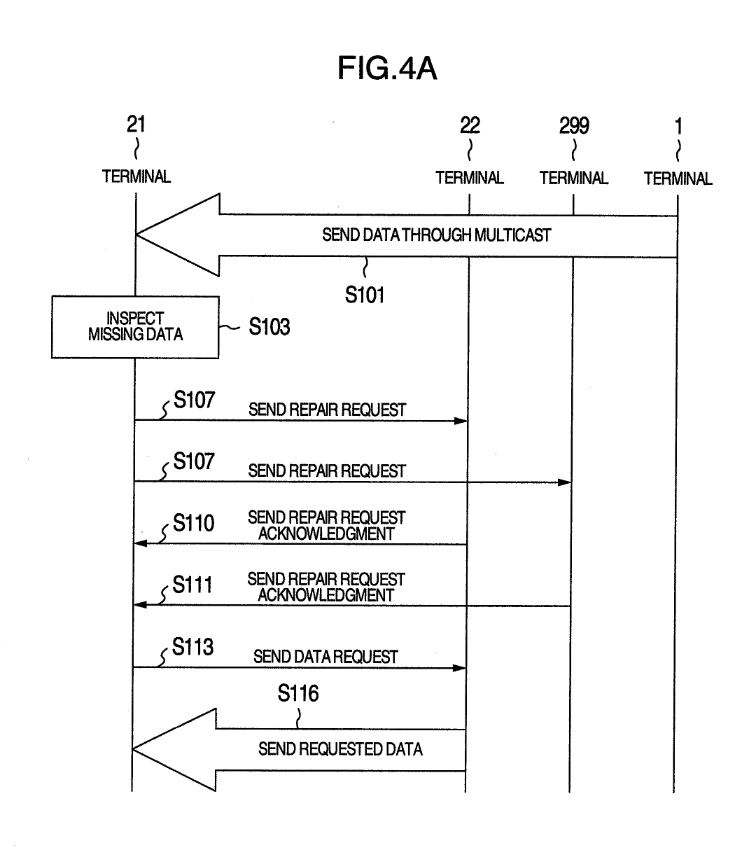

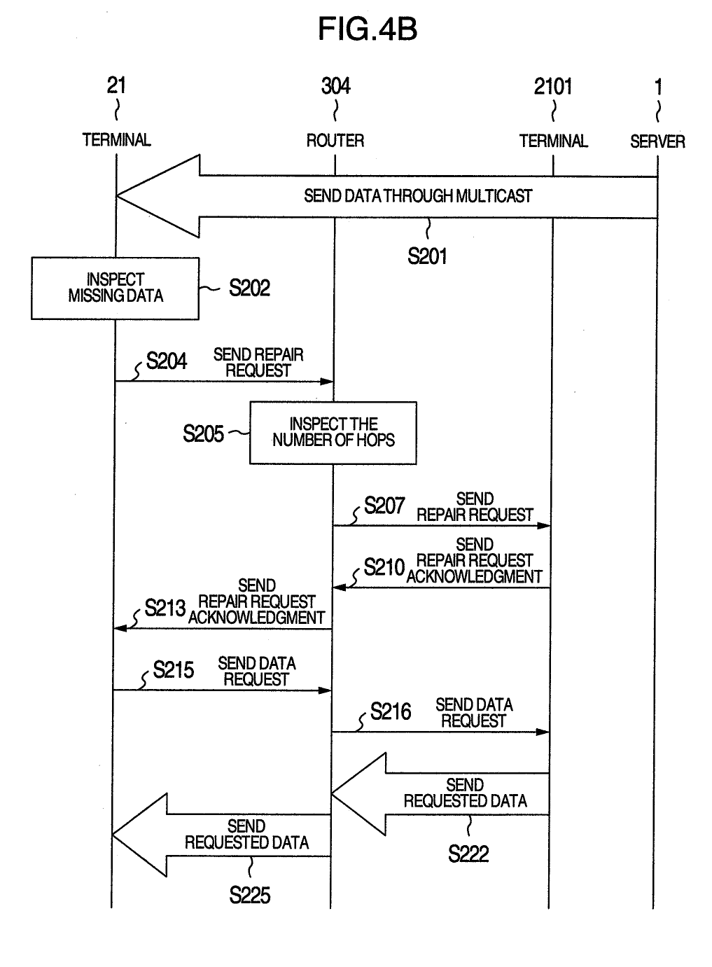

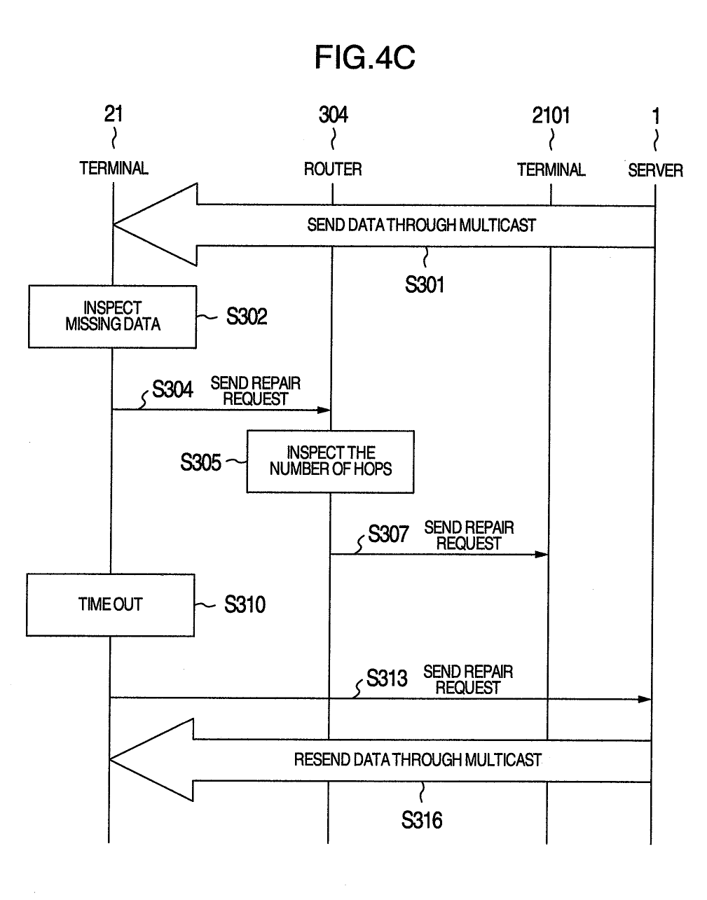

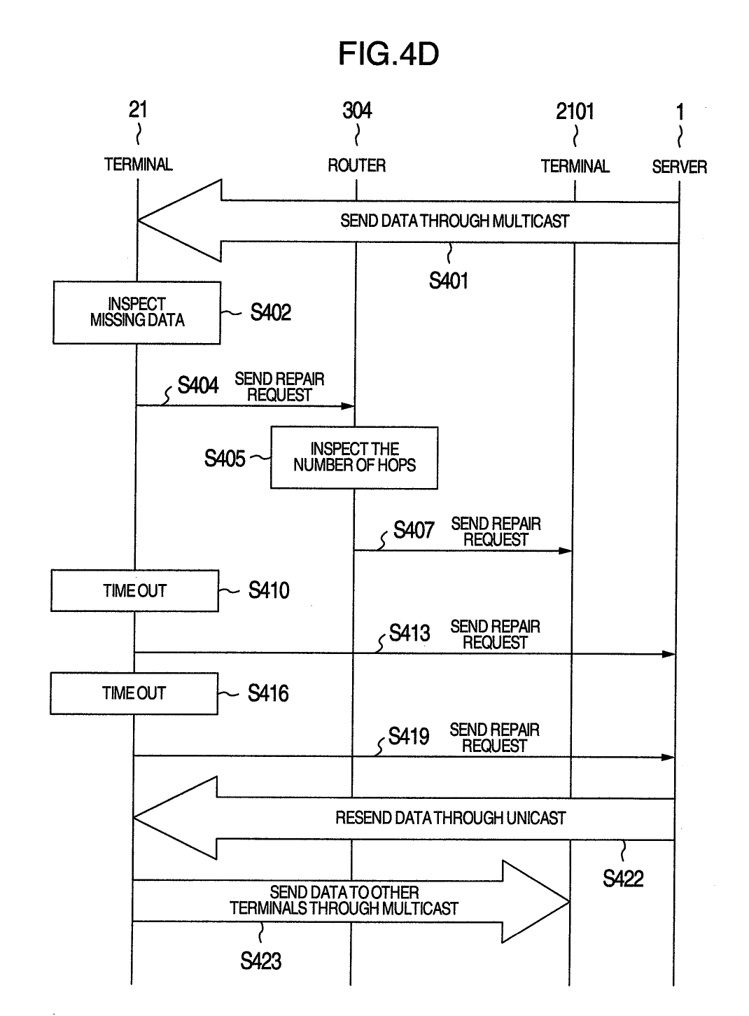

FIGS. 4A to 4D are various signaling flow diagrams in which the terminal requests repair data. FIG. 4A is a signaling flow diagram in which the terminal 21 acquires the repair data from the next terminal 22. The server 1 sends data to the terminals through multicast (S101). When detecting missing data (S103), the terminal 21 sends a repair request message to the other terminals through multicast (S107). When each having a request data set and failing to receive a repair request acknowledgment message from the other terminals, the terminals 22 and 299 that each receive the repair request message send back the repair request acknowledgment message through multicast (S110 and S111). The terminal 21 sends back a data request message through unicast (S113) to the terminal 22 that first sends the repair request acknowledgment message (S110). The terminal 22 that receives the data request message (S113) transfers the repair data to the terminal 21 and the other terminals through multicast (S116).

FIG. 4B is a signaling flow diagram in which the terminal 21 acquires repair data from other terminals at a long distance. The server 1 sends data to the terminals through multicast (S201). When detecting the missing data (S202), the terminal 21 sends a repair request message to the router 304 through multicast (S204). When receiving the repair request message, the router 304 inspects the number of hops (S205). When the number of hops is greater than one, the router 304 transfers the repair request message to the other links after subtracting one from the number of hops (S207). When having the requested repair data, a terminal 2101 of another link sends back a repair request acknowledgment message through multicast (S210). The router 304 transfers the repair request acknowledgment messages to the terminal 21 and the other terminals (S213). Further, the terminal 21 sends a data request message to a terminal 2101 (S215) where the data request message is transferred to the terminal 2101 by a router 304 (S216). The terminal 2101 transfers repair data to the router 304 through multicast (S222), and the router 304 transfers the repair data to the terminal 21 and the other terminals (S225).

FIG. 4C is a Signaling Flow Diagram in which the terminal 21 acquires repair data from the server 1. The server 1 sends repair data to the terminals through multicast (S301). When detecting damaged or missing data (S302), the terminal 21 sends a repair request message to the other terminals through multicast (S304). When receiving the repair request message, the router 304 inspects the number of hops (S305). When the number of hops is greater than one, the router 304 transfers the repair request message to the other links after subtracting one from the number of hops (S307). Even if a waiting time is timed out (S310), when failing to receive a repair request acknowledgment message, the terminal 21 sends a repair request message to the server 1 (S313). After receiving the repair request message, the server 1 retransmits the repair data through multicast (S316).

FIG. 4D is a signaling flow diagram in which the terminal 21 acquires repair data through highly reliable unicast. A message flow diagram from S401 to S413 is the same as that from S301 to S313 in FIG. 4C. Even if a waiting time is timed out (S416), when failing to receive correct repair data sent from the server 1, the terminal 21 retransmits a repair request message to the server 1 (S419). When receiving the same repair request message from the same terminal one or more times, the server 1 retransmits the repair data to the terminal through highly reliable unicast (S422). The terminal 21 transfers the received repair data to the other terminals through multicast (S423).

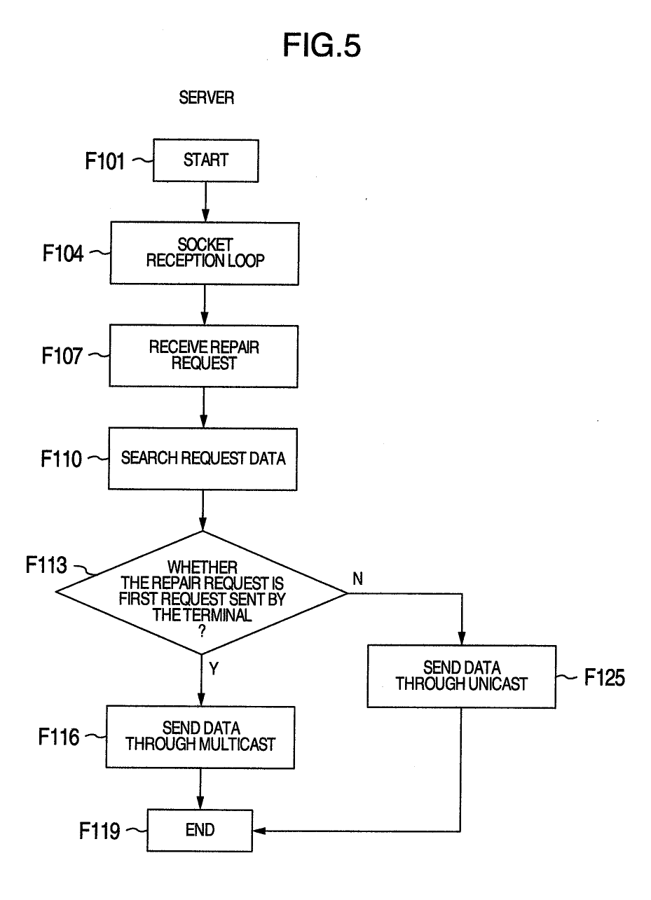

FIG. 5 is a flowchart in which the server 1 receives and processes a repair request from the terminal 2. The server 1 sends data to the terminals 2 (F101), and monitors feedback messages from the terminals 2 (F104). When receiving a repair request message from the terminal 2 (F107), the server 1 searches for data necessary for retransmission (F110). The server 1 inspects a repair request database 143, and further inspects how many times the terminal 2 sends a repair request corresponding to the data (F113). When the terminal 2 sends the repair request once, the server 1 retransmits requested data through multicast (F116) and then ends a process (F119). When the terminal 2 sends the repair request twice or more, the server 1 sends the repair data to the terminal 2 through unicast (F125).

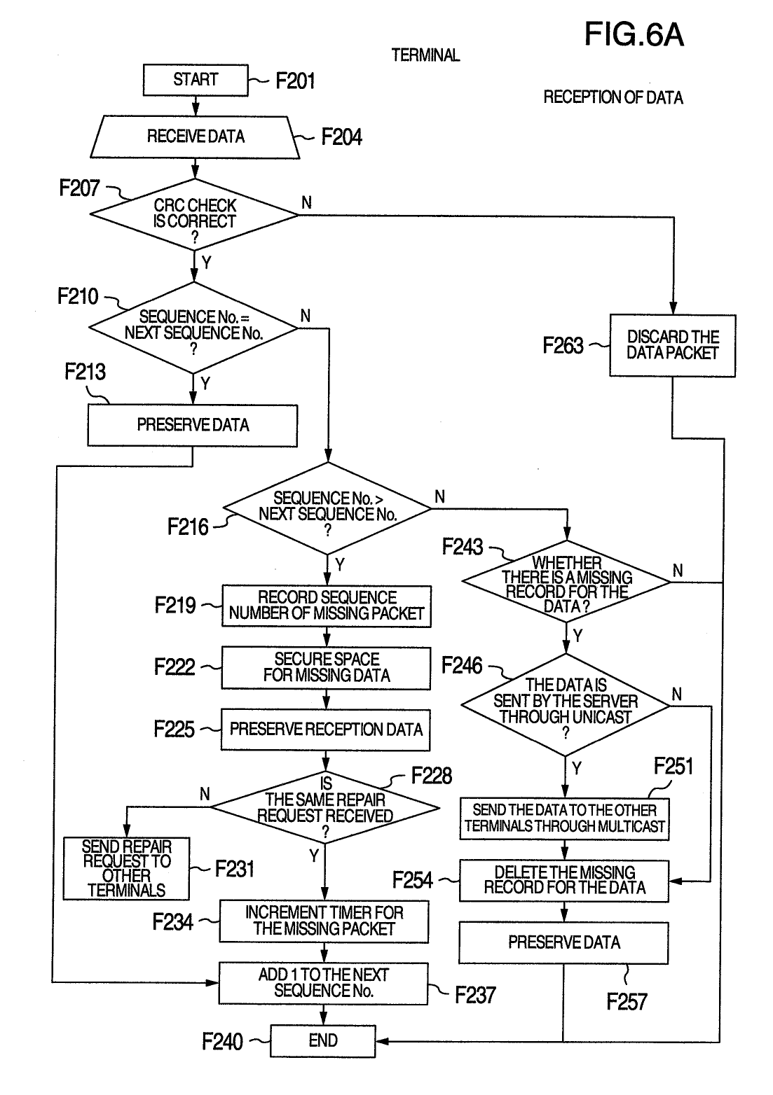

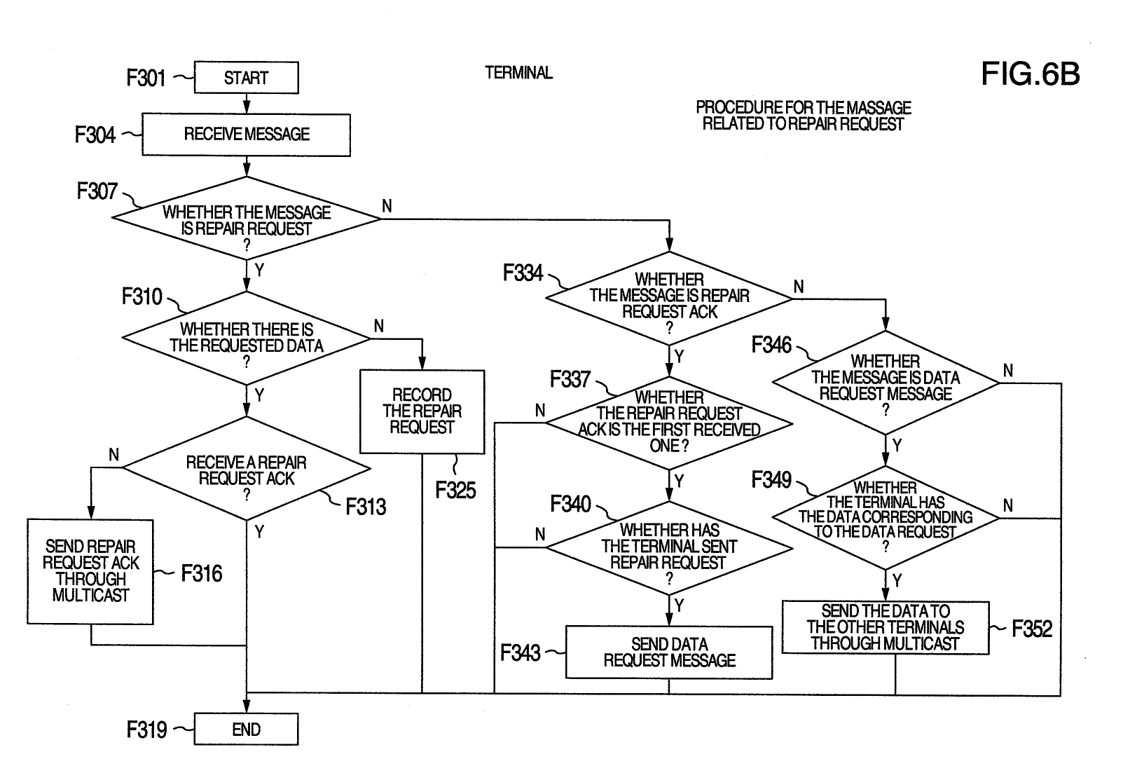

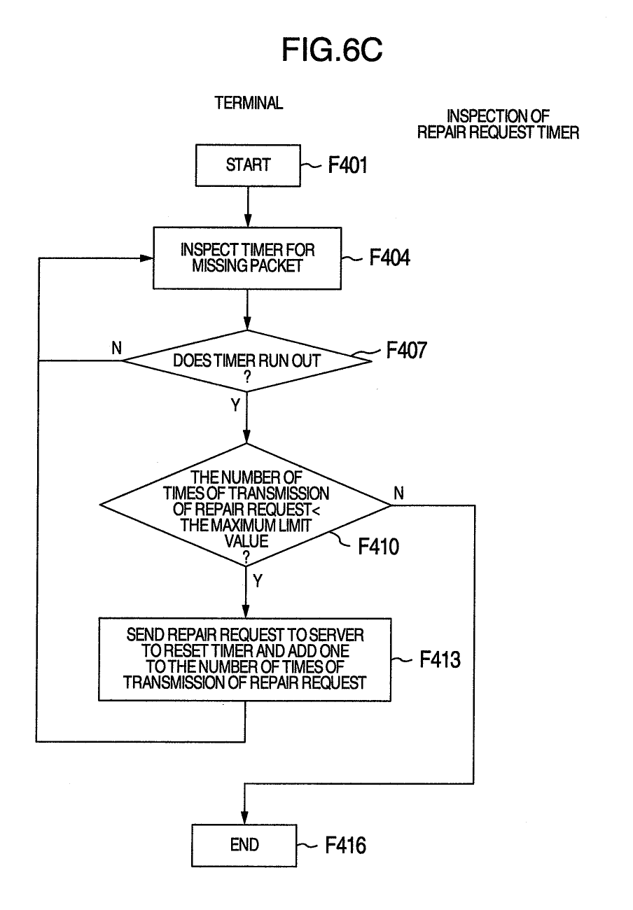

FIG. 6A is a flowchart in which the terminal 2 receives data to perform an integrity test. The terminal 2 completes reception preparations for data (F201). After receiving data (F204), the terminal 2 first performs a cyclic redundancy check (CRC) (F207). When the result is incorrect, the terminal 2 discards the data packet (F263). When the result is correct, the terminal 2 further inspects a sequence number of the data. When the sequence number is the same as that of the next expected data (F210), the terminal 2 preserves the data and adds one to the next sequence number (F237). When the sequence number is greater than the next sequence number (F216), this means the missing data. The terminal 2 records the sequence number of the missing packet (F219), secures a space for the missing data (F222), and stores the reception data (F225). Thereafter, the terminal 2 inspects whether to receive a repair request message corresponding to the missing data sent from the other terminals (F228). When failing to receive the repair request message, the terminal 2 sends the repair request message to the other terminals (F231). When receiving the repair request message, the terminal 2 increments a timer for the missing record (F234) and adds one to the sequence number of the next data packet (F237). When the sequence number of the reception data packet is equal to or less than that of the next data packet, this means that the terminal 2 receives retransmission data. The terminal 2 first determines whether there is a missing record for the data (F243). When there is not a missing record for the data, the terminal 2 neglects the data, whereas when there is a missing record for the data, the terminal 2 further inspects whether the data is sent by the server 1 through unicast (F246). When the data is sent by the server 1, the terminal 2 transfers the data to the other terminals through multicast (F251), and deletes the missing record for the data (F254). When the data is not sent by the server 1, the terminal 2 directly deletes the missing record for the data (F254). Lastly, the terminal 2 preserves the repair data (F257), and ends a reception process for the data (F240).

FIG. 6B is a flowchart in which the terminal 2 receives and processes the repair request. When receiving a repair request type message (F304), the terminal 2 first determines whether the message is a repair request message (F307), whether the message is a repair request acknowledgment message (F334), or whether the message is a data request message (F346). When the message is a repair request message, the terminal 2 searches whether there is requested data (F310). When there is the requested data, the terminal further inspects whether to receive an acknowledgment message corresponding to the repair request (F313). When failing to receive the acknowledgment message, the terminal 2 sends back a repair request acknowledgment message through multicast (F316). When there is not the requested data, the terminal 2 records the repair request message information (F325). When the received message is a repair request acknowledgment message (F334), the terminal 2 further determines whether the repair request acknowledgment message is the first received one (F337). If YES, the terminal 2 inspects whether to have sent a repair request message corresponding to the data (F340). When having sent the repair request message, the terminal 2 sends back a data request message through unicast (F343). When the message is a data request message (F346), the terminal 2 inspects whether to have the data corresponding to the data request (F349). When having the data corresponding to the data request, the terminal 2 sends the requested data to the other terminals through multicast (F352). Thereafter, the terminal 2 ends a process corresponding to the message (F319).

FIG. 6C is a flowchart in which the terminal 2 performs timer inspection to the missing record. The terminal 2 inspects a timer for the missing packet (F404). When the timer for a certain missing packet runs out (F407), the terminal 2 determines whether the number of times of transmission of repair request is smaller than the maximum number of times of retransmission (F410). If YES, the terminal 2 sends a repair request to the server 1 and adds one to the number of times of transmission of repair request (F413). If NO, the terminal ends the process without sending the repair request (F416).

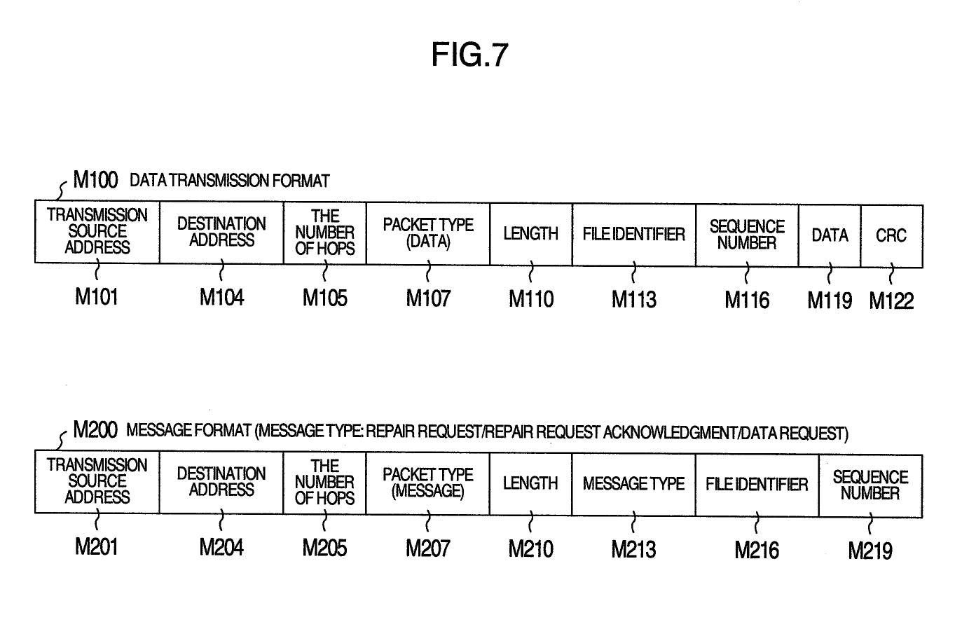

FIG. 7 is a combined sketch of a data transmission format and a repair request message format. M100 is the data transmission format, and includes fields of transmission source address M101, destination address M104, the number of hops M105, packet type M107, size MN110, file identifier M113, sequence number M116, data M119, and CRC M122. In the number of hops M105, the number of times of transmission of the data via a router is specified, and one is subtracted from the number of hops for each transmission. In the packet type M107, it is specified that the data session is either data or message. In the file identifier M113, an identifier for the file is uniquely identified. In the sequence number M116, a position in a file of the session data is specified. In the data M119, a content for transmission is specified. In the CRC M122, a cyclic redundancy check value is specified.

M200 is the repair request and related message format, and includes fields of transmission source address M201, destination address M204, the number of hops M205, packet type M207, size M210, message type M213, file identifier M216, and sequence number M219. In the message type M213, it is specified that the message is a repair request message, or a repair request acknowledgment message, or a data request message. Meanings of the other fields are the same as those of the fields of M100.

The data transmission system according to the present invention can reduce data retransmissions from the server to the terminals, and reduce the same retransmission requests from the terminals to the server to save the band width, and further, avoid the retransmission request congestion problem due to a fact that the same retransmission requests reach the server at the same time. Therefore, the present invention is widely applicable to communication fields.

It should be further understood by those skilled in the art that although the foregoing description has been made on embodiments of the invention, the invention is not limited thereto and various changes and modification may be made without departing from the spirit of the invention and the scope of the appended claims.

1. A terminal comprising:
a network interface unit that connects to a network and communicates with a further terminal or a server via the network;
a storage unit that stores reception data and information on missing data;
a detection unit that detects that the reception data is missing or damaged; and
a controller that controls the network interface unit to send a repair request message to the further terminal through multicast when the detection unit detects the missing or damaged data among data sets received from the server, and that controls the network interface unit to send a repair request message to the server when there is not requested data in the further terminal.

2. The terminal according to claim 1, wherein:
the network interface unit includes a data request message transmission/reception module and a data transmission/reception module;
the data request message transmission/reception module sends a data request message to the further terminal or the server, and receives a data request message from the further terminal; and
the data transmission/reception module transfers requested data to the further terminal, and receives data from the further terminal or the server.

3. The terminal according to claim 2, wherein:
the storage unit includes a data storage module and a packet error/missing database;
the data storage module stores data received by the data transmission/reception module; and
the packet error/missing database records information for error or missing data.

4. The terminal according to claim 3, wherein:
the detection unit includes a packet error/missing detection module, a repair request message transmission module, and a repair request process module;
the packet error/missing detection module detects whether reception data is correct and whether the reception data is missing, and records information for error or missing data in the packet error/missing database,
the repair request message transmission module sends a repair request message to the further terminal or the server, and
the repair request process module receives a repair request message, and searches whether there is repair request data from the further terminal, and sends back a repair request acknowledgment message through multicast.

5. The terminal according to claim 4, wherein:
when an error or missing data is detected, the controller controls the repair request message transmission module to send the repair request message to the further terminal through multicast; and
when receiving the repair request message sent from the further terminal, the repair request process module searches whether there is repair request data from the further terminal, and when there is the requested data, the repair request process module sends back a repair request acknowledgment message through multicast.

6. The terminal according to claim 5, wherein:
when the repair request process module receives the repair request acknowledgment message, the controller controls the data request message transmission/reception module to send a data request message through unicast to a terminal that first sends back the repair request acknowledgment message;
when the data request message transmission/reception module receives a data request message, the controller controls the data transmission/reception module to send requested data to the further terminal through multicast; and
when the packet error/missing detection module detects the error or missing data and when the repair request process module fails to receive the repair request acknowledgment message, the controller controls the repair request message transmission module to send the repair request message to the server.

7. The terminal according to claim 1, wherein:
when said terminal fails to receive the requested data from the further terminal within a predetermined time, the controller controls the network interface unit to send the repair request message to the server.

8. The terminal according to claim 7, wherein:
when the network interface unit sends a repair request message to the server and then fails to receive data sent from the server through multicast after the predetermined time has elapsed, the controller controls the network interface unit to retransmit the repair request message to the server and said terminal receives the requested data sent from the server through unicast.

9. A data transmission system capable of highly reliable multicast transmission of data, comprising:
a server;
a network; and
a plurality of terminals,
wherein the server sends data to one or more of the terminals via the network and the network connects the server and the plurality of terminals; and
wherein each of the terminals includes:
a network interface unit that connects to the network and communicates with the terminals or the server via the network;
a storage unit that stores reception data and information on missing data;
a detection unit that detects that the reception data is missing or damaged; and
a controller that controls the network interface unit to send a repair request message to two or more of the terminals through multicast when the detection unit detects the missing or damaged data among data sets received from the server, and that controls the network interface unit to send a repair request message to the server when there is not requested data in the other terminals.

10. The data transmission system according to claim 9, wherein:
the network has a plurality of network devices that support the multicast.

11. The data transmission system according to claim 10, wherein:
the network device is a router.

12. A data transmission method capable of highly reliable multicast transmission of data, in a data transmission system comprising a server, a network, and a plurality of terminals, the method comprising:
causing the server to send data to the plurality of terminals via the network through multicast;
causing a terminal to detect that reception data is missing or damaged;
causing said terminal to send a repair request message to a further terminal through multicast when it is detected that the data is missing or damaged;
causing said terminal to repair the missing or damaged data when said terminal receives the data sent from the further terminal;
causing said terminal to send a repair request message to the server when the data sent from the further terminal is not received after a predetermined time has elapsed; and
causing said terminal to receive the data retransmitted from the server through multicast to repair the missing or damaged data.

13. The data transmission method according to claim 12, wherein:
after sending the repair request message, said terminal sends a data request message to a terminal that first sends back a repair request acknowledgment message.

14. The data transmission method according to claim 12, wherein:
when receiving the repair request acknowledgment message sent from the further terminal, said terminal does not retransmit the repair request acknowledgment message.

15. The data transmission method according to claim 12, wherein:
said terminal sends to the further terminal the retransmitted data received from the server through multicast.

16. The data transmission method according to claim 12, wherein:
when said terminal sends a repair request message to the server and then fails to receive the data sent from the server through multicast after a predetermined time has elapsed, said terminal retransmits the repair request message to the server and the server retransmits the data to said terminal through unicast.
